(19) United States
(12) Patent Application Publication
(10) Pub. No.: US 2005/0077842 A1
(43) Pub. Date: Apr. 14, 2005

(54) Circuit arrangement for operation of one or more lamps

(76) Inventors: Ulrich Boke, Langerwehe (DE); Antoon J Bock, Landgraaf (NL)

Correspondence Address: PHILIPS INTELLECTUAL PROPERTY & STANDARDS, P.O. BOX 3001, BRIARCLIFF MANOR, NY, 10510, US

(21) Appl. No.: 10/500,508

(22) PCT Filed: Dec. 18, 2002
(86) PCT No.: PCT/IB02/05467

(30) Foreign Application Priority Data
Jan. 2, 2002 (DE) 102 00 022.0

(51) Int. Cl. H05B 37/00

(52) U.S. Cl. 315/312

(57) ABSTRACT

The invention relates to a background lighting system for a liquid crystal display, more particularly to an electronic circuit for operation of one or more discharge lamps. A DC/AC full-bridge inverter circuit generates two voltages whose AC components are phase-shifted by 180°. The discharge lamps are supplied with the sum of these two AC voltages.

The invention relates to a circuit arrangement for operating one or more low-pressure gas discharge lamps, comprising a current converter and a driving device for the current converter.

Such a circuit arrangement for operating one or more low-pressure gas discharge lamps is known from DE 44 36 463 A1. This particularly relates to a circuit arrangement which is suitable for operation of compact low-pressure gas discharge lamps whose operating voltage exceeds the AC voltage generated by the converter and is suitable for the operation of miniature phosphor lamps. In these circuit arrangements the principle of resonance step-up is used not only for generating the ignition voltage necessary for the low-pressure gas discharge lamp, but also for supplying the operating voltage of the lamp. This implies a reactive power flux at the operating voltage.

High voltages can also be generated by using a transformer such as described in U.S. Pat. No. 6,181,079 B1. Such transformers are awkward and heavy.

It is therefore an object of the invention to indicate a simple circuit arrangement for igniting and operating such lamps. More particularly a circuit arrangement is indicated that feeds a plurality of low-pressure gas discharge lamps in the background lighting of a liquid crystal display from a voltage source.

This object is achieved in accordance with the characteristic features of claim 1. According to the invention a second current converter generates a voltage shifted by 180°.

Liquid crystal displays, also called LCDs for short, are nowadays also used as liquid crystal picture screens. The liquid crystal picture screens are passive display systems i.e. they do not light up by themselves. These picture screens are based on the principle that light either passes the layer of liquid crystals or not. This means that an external light source is necessary for producing a picture. For this purpose an artificial light is generated in the background lighting system. With an increasing size of the liquid crystal picture screens, also the performance level for the background lighting system of such picture screens increases. Lamps of small diameter are desired for these background lighting systems. Compared to other low-pressure gas discharge lamps in lighting arrangements, low-pressure gas discharge lamps in background lighting systems of liquid crystal picture screens have a smaller inner diameter from 2 mm to 3.5 mm and, therefore, four to eight times higher lamp voltages. Thinner lamps for LCDs such as Ceralight lamps as known from EP 1 263 021 A1 work with 300 to 400 volts operating voltage, and cold cathode lamps in the following called Cold Cathode Fluorescent Lamps or CCFLs for short, work with 600 to 800 volts operating voltage. The ignition voltages to start these lamps are moreover higher by a factor of two. These high ignition and operating voltages for thin low-pressure gas discharge lamps are generated without a transformer in that the low-pressure gas discharge lamps are supplied with power by two series-connected AC voltages. Since the two AC voltages have a 180° phase difference, the sum of the two AC voltages is applied to the low-pressure gas discharge lamp. In addition, these AC voltages are generated with moderate reactive power flux in the resonant circuits. For this purpose, the circuit arrangement has low power losses and thus a smaller thermal load in the closed housing of the liquid crystal picture screen.

A circuit arrangement advantageously converts DC voltage into AC voltage and feeds one or several lamps which use a full-bridge switching circuit of power switches as a current converter and two resonant circuits per lamp, each of the resonant circuits comprising one series-connected coil, one series-connected capacitor and one parallel-connected capacitor. This circuit arrangement comprises one full-bridge current converter and one resonant circuit per lamp. This provides that any number of lamps can be operated with a single current converter. This converter is thus scalable. The advantage of the full-bridge converter is that it generates a double output voltage compared to a half-bridge converter, without utilizing a transformer. The two half bridges work with 180° phase distance. The ignition of the lamps and the power flux at normal operation is controlled by the switching frequency. The input impedance of the resonant circuit is then always ohmic inductive to have the power semiconductors of the full-bridge converter operate with minimum switching losses. This configuration has the advantage of a lower voltage load of the parallel capacitors.

The resonant circuits can additionally be constructed in three further circuit arrangements. Advantageously, a second circuit arrangement converts DC current into AC current and feeds one or more lamps which utilize a full-bridge circuit of power switches as a current converter, two series-connected capacitors and two resonant circuits per lamp, each of the resonant circuits comprising a series-connected coil and a parallel-connected capacitor.

A third circuit arrangement advantageously converts DC current into AC current and feeds one or more lamps which utilize a full-bridge switching circuit comprising power switches as a current converter and one resonant circuit per lamp, which resonant circuit comprises one series-connected coil, one series-connected capacitor and one parallel-connected capacitor.

A fourth circuit arrangement advantageously converts DC current into AC current and feeds one or more lamps which utilize a full-bridge switching circuit with power switches as a current converter, two series-connected capacitors and one resonant circuit per lamp, which resonant circuit comprises one series-connected coil and one parallel-connected capacitor.

The parallel-connected capacitor is advantageously formed at least partly by a parasitic capacitance between the lamps and a metallic portion, thus the lamp electrodes and the electrically conductive parts of the display, for example, of the reflector.

To better understand the invention, an example of embodiment will be further explained hereinbelow with reference to the drawing in which:

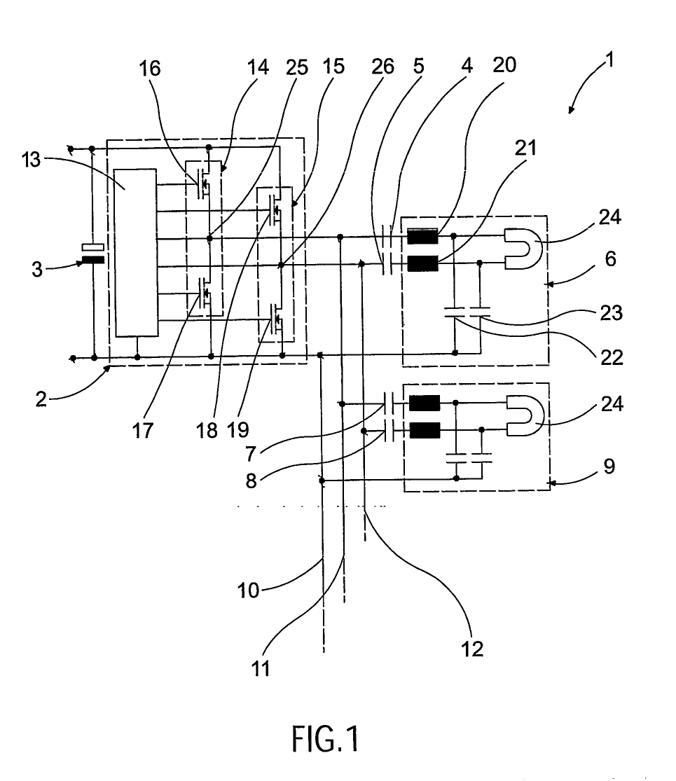

FIG. 1 shows a circuit arrangement for converting DC current into AC current and for feeding one or more low-pressure gas discharge lamps,

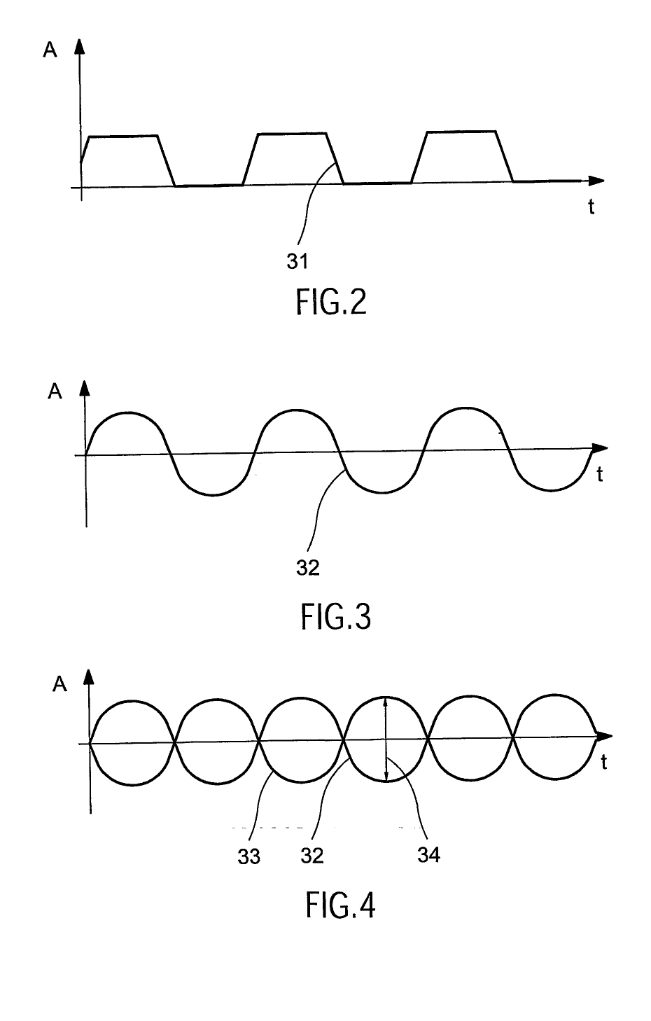

FIG. 2 shows a timing diagram with a rectangular signal waveform,

FIG. 3 shows a timing diagram with a sine curve,

FIG. 4 shows a timing diagram with two sine curves phase-shifted by 180°,

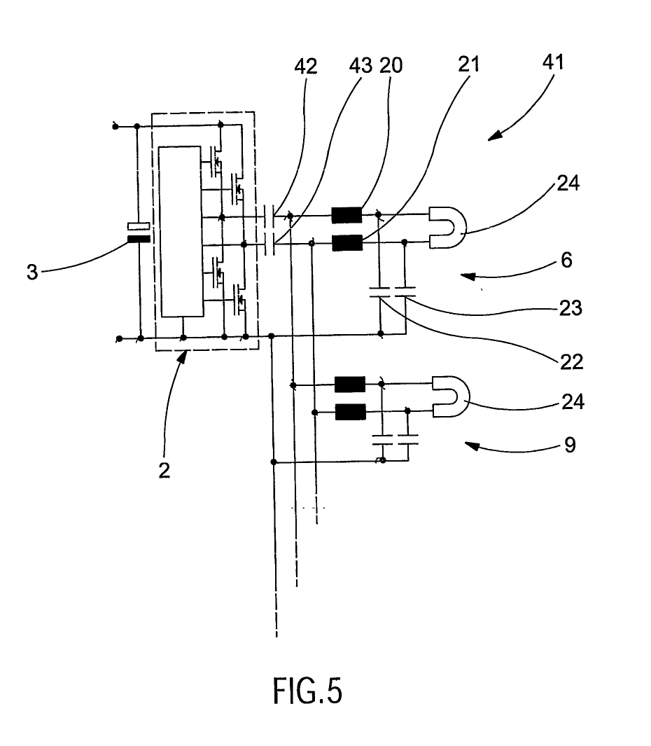

FIG. 5 shows a second circuit arrangement for converting DC current into AC current and for feeding one or more low-pressure gas discharge lamps,

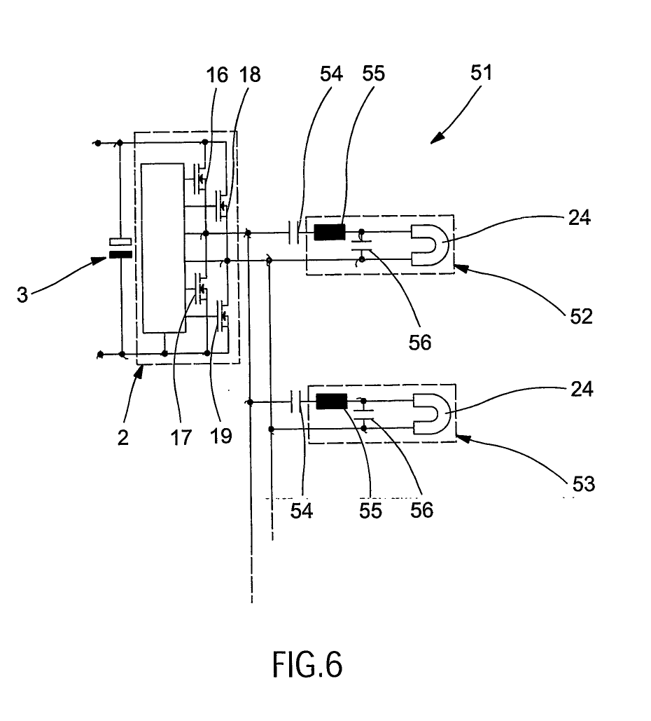

FIG. 6 shows a third circuit arrangement for converting DC current into AC current and for feeding one or more low-pressure gas discharge lamps,

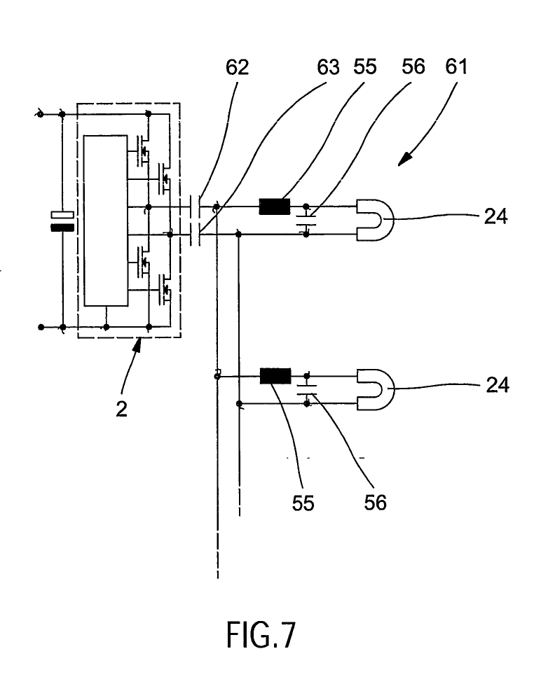

FIG. 7 shows a fourth circuit arrangement for converting DC current into AC current and for feeding one or more low-pressure gas discharge lamps, and

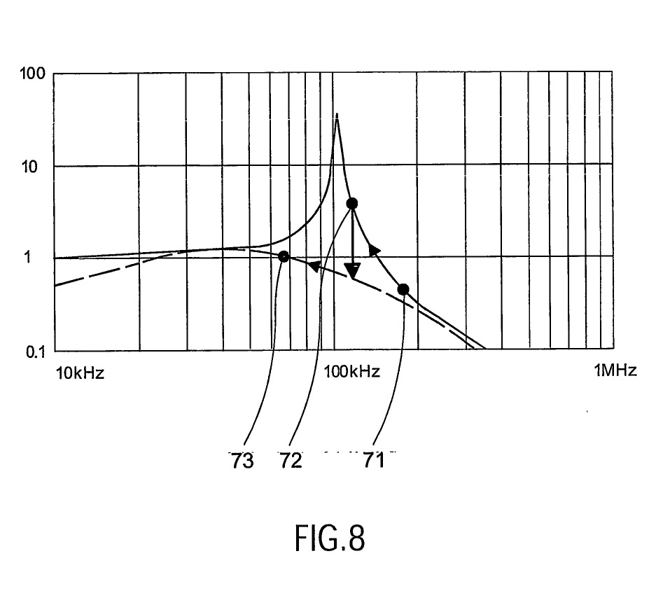

FIG. 8 shows a diagram with a voltage ratio plotted against frequency.

FIG. 1 shows an electronic circuit arrangement 1 comprising a full-bridge switching circuit 2, a voltage source 3, two low-pass filters 4 and 5, a first lamp switching circuit 6, two further low-pass filters 7 and 8 and a second lamp switching circuit 9. Electrically conducting lines 10, 11 and 12 lead to further lamp switching circuits (not shown). The full-bridge switching circuit 2 also called full-bridge inverter in the following, comprises a control circuit 13 and two current converters 14 and 15. The current converter 14, in the following also called inverter, includes two power switches 16 and 17, and the second inverter 15 also includes two power switches 18 and 19. Power semiconductors such as bipolar transistors, IGBTs (Integrated Gate Bipolar Transistors) are also MOSFETs are used as power switches. Tone first lamp switching circuit 6 includes two series-connected coils 20 and 21, two parallel-connected capacitors 22 and 23 and one low-pressure gas discharge lamp 24. The second lamp circuit 9 has a similar structure with components 20 to 24. The control circuit 13 controls the first inverter 14 so that the power semiconductors 16 and 17 open and close in a push-pull mode. A rectangular signal waveform evolves at a node 25 between the power semiconductors 16 and 17. The control circuit 13 controls the second inverter 15 so that the power semiconductors 18 and 19 also open and close in a push-pull mode. A rectangular signal waveform also evolves at a node 26 between the power semiconductors 18 and 19. The two inverters 14 and 15 work in phase opposition, so that two rectangular signal waveforms evolve shifted by 180°. The low-pass filters 4, 5, 7 and 8 filter out the high-frequency components, so that two sinusoidal signals shifted in phase by 180° reach the lamps 24. The series-connected coil 20 and the parallel-connected capacitor 22 form a first resonant circuit 20, 22, the coil and the capacitor 23 form a second resonant circuit 21, 23. The low-pass filters 4 and 5, the coils 20 and 21 and the lamp 24 are connected in series between the two nodes 25 and 26. The capacitors 22, 23 are connected in parallel to the lamp 24 and to the minus pole of the DC voltage source 3. The half lamp voltage is applied via the capacitors 22 and 23, respectively.

FIG. 2 shows a rectangular signal waveform 31 which arises at the node 25. A similar signal waveform arises at node 26. The two rectangular signal waveforms are phase-shifted by 180°.

FIG. 3 shows a sinusoidal signal waveform 32 which evolves as a result of the smoothing by the low-pass filter 4.

FIG. 4 shows a sine curve 32 and a second sine curve 33 shifted by 180°, which is filtered by the low-pass filter 5. In this way a maximum voltage amplitude 34 corresponding to the value of the voltage supply 3 arises at the lamp 24.

FIG. 5 shows a second circuit arrangement 41 comprising a full-bridge inverter 2 and the lamp switching circuits 6 and 9. Two low-pass filters 42 and 43 filter out the high-frequency components for all the lamp circuits 6 and 9.

FIG. 6 shows a third circuit arrangement 51 comprising the full-bridge inverter 2, the voltage source 3 and two lamp switching circuits 52 and 53. Between the two nodes 25 and 26 in the lamp circuit 52 is connected a capacitor 54, a coil 55 and a capacitor 56 which together work as a low-pass filter, and a low-pressure gas discharge lamp 24 in parallel with capacitor 56. The coil 55 and the capacitor 56 form a resonant circuit 55, 56.

The coil 55 has double the inductance of coil 20, the capacitor 56 half the capacitance of the capacitor 22. There is a voltage drop across the capacitor 56, which drop corresponds to the lamp voltage.

FIG. 7 shows an electrical circuit arrangement 61 with two series-connected capacitors 62, 63 which work for all the lamp circuits 52, 53.

FIG. 8 shows a diagram in which the voltage is plotted against frequency. The AC power gain function of a resonant circuit is shown as a function of the switching frequency. To ignite a low-pressure gas discharge lamp, the full-bridge starts with a starting frequency 71, reduces the switching frequency until the lamp ignites at an ignition frequency 72 and reduces the switching frequency further to an operating frequency 73.

List of Reference Characters:

1 circuit arrangement

2 full-bridge inverter

3 voltage source

4 low-pass filter

5 low-pass filter

6 lamp switching circuit

7 low-pass filter

8 low-pass filter

9 lamp switching circuit

10 electrically conducting line

11 electrically conducting line

12 electronically conducting line

13 control circuit

14 inverter

15 inverter

16 power switch

17 power switch

18 power switch

19 power switch

20 series coil

21 series coil

22 capacitor

23 capacitor

24 lamp

25 node

26 node

31 rectangular signal waveform

32 sinusoidal fundamental wave

33 second sinusoidal fundamental wave

34 voltage amplitude

41 second circuit arrangement

42 low-pass filter

43 low-pass filter

51 third circuit arrangement

52 lamp switching circuit

53 lamp switching circuit

54 capacitor

55 coil

56 capacitor

61 four circuit arrangement

62 capacitor

63 capacitor

71 start frequency

72 ignition frequency

73 operating frequency

1. A circuit arrangement (1, 41, 51, 61) for operating one or more low-pressure gas discharge lamps (24), comprising a current converter (14) and a driving device (13) for the current converter (14), characterized in that a second current converter (15) generates a voltage (32, 33) phase-shifted by 180°.

2. A circuit arrangement (1) for converting DC current into AC current and for feeding one or more low-pressure gas discharge lamps (24) which utilizes a full-bridge switching circuit (2) with power switches (16, 17, 18, 19) as current converters (14, 15) and two resonant circuits (4, 5, 20, 21, 22, 23) per lamp (24), each of the resonant circuits (4, 5, 20, 21, 22, 230 having a series-connected coil (20, 21), one series-connected capacitor (4, 5) and one parallel-connected capacitor (22, 23).

3. A circuit arrangement (41) for converting DC current into AC current and for feeding one or more low-pressure gas discharge lamps (24), which utilizes a full-bridge switching circuit (2) including power switches (16, 17, 18, 19) as current converters (14, 15), two series-connected capacitors (42, 43) and two resonant circuits (20, 21, 22, 23) per lamp (24), each of the resonant circuits (20, 21, 22 or 23) having one series-connected coil (20, 21) and one parallel-connected capacitor (22, 23).

4. A circuit arrangement (51) for converting DC current into AC current and for feeding one or more low-pressure gas discharge lamps (24) which utilizes a full-bridge switching circuit (2) with power switches (16, 17, 18, 19) as current converters (14, 15) and one resonant circuit (54, 55, 56) per lamp (24), which resonant circuit includes one series-connected coil (55), one series-connected capacitor (54) and one parallel-connected capacitor (56).

5. A circuit arrangement (61) for converting DC current into AC current and for feeding one or more low-pressure gas discharge lamps (24), which utilizes a full-bridge switching circuit (2) with power switches (16, 17, 18, 19) as current converters (14, 15), two series-connected capacitors (62, 63) and one resonant circuit (55, 56) per lamp (24), which resonant circuit includes a series-connected coil (55) and a parallel-connected capacitor (56).

6. A circuit arrangement as claimed in claim 2, characterized in that the parallel-connected capacitor (22, 23, 56) is formed at least partly by a parasitic capacitance between the lamp (24) and a metallic part.

7. A liquid crystal display on which a video signal of a computer or of a television set can be represented, comprising a circuit arrangement (1, 41, 51, 61) as claimed in claim 1.
